(19) United States
(12) Patent Application Publication
(10) Pub. No.: US 2007/0252380 A1
(43) Pub. Date: Nov. 1, 2007

(54) High gloss film based pressure sensitive prime label assembly having enhanced imaged resolution

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/348,826

(22) Filed: Feb. 7, 2006

(51) Int. Cl. B42D 15/00

(52) U.S. Cl. 283/101

(57) ABSTRACT

A prime label assembly is created on a substantially transparent substrate by printing a reverse image on one side of the substrate and then over coating at least a portion of the image with a white pigmented layer which may be provided in a density gradient. The white pigmented layer is covered with a pressure sensitive adhesive which is then covered with a release liners.

CROSS-REFERENCES TO RELATED APPLICATIONS

None.

### FIELD OF THE INVENTION

The present invention is in the field of finished product and intermediate manufacturing methods that are used in the preparation of articles, such as pressure sensitive laminates, intended for use as a prime label construction. More particularly, such laminated assemblies may be used in the production of prime label products having a glossy appearance occasioned through the printing on a clear or substantially transparent film.

The present invention is used to produce high color, pressure sensitive business and marketing communication that can be manufactured in a unique process. The web or sheets are preferably printed with high quality graphics or images, in a reverse format (so as to be visible through the face of the substrate) and which are then slit or cut (e.g. die cut) to size (regular and irregular shapes) for the particular application as may be specified by the end user. The pressure sensitive intermediate of the instant application can be used to create individual, prime label products that have, preferably a high or photo quality resolution level of greater than about 150 lines per inch and preferably such as those about 300 lines per inch or approximately 2500 to 3500 dots per inch. In addition, through use of the present invention, a label image may be created that will permit some image growth such as through ink dot expansion.

### BACKGROUND OF THE INVENTION

There are currently a plethora of business communication constructions, marketing and advertising pieces and other items that are available in the market today for communicating products and services with an intended audience. Yet with this inordinately large selection of offerings and permutations, there remains a continuing need to develop new products due to changes in technology, societal trends, diversification of marketing, packaging and advertising campaigns and new information handling needs of businesses and consumers alike.

Today, there are wide varieties of product offerings available that serve multiple purposes and functions, including product offerings that are used in fulfilling the needs in the prime label market. Conventional processes that are used today in creating prime labels are typically based on a continuous web technology using flexographic presses. The traditional process of manufacturing such label products includes the feeding of a continuous web of material, such as a preformed web of pressure sensitive laminate, which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Prime labels having a glossy appearance may also be produced in which an “optically clear” product is created. In this process, a film liner is provided with a substantially transparent adhesive, and the liner is positioned over the prime label substrate and through the use of the adhesive, the liner is temporarily affixed to the label substrate. The liner, which acts as a release liner or material, is then stripped away and a clear polyethylene sheet (PET) is applied over the top of the adhesive. Ideally, the positioning of the film is done so as to not create any bubbles or other imperfections in the surface of the label. Obviously, such a process can create surface distortions as well as create additional steps in the manufacture of such products, which may be costly and reduce the number of potential applications for which the prime label products may be utilized.

Flexography is commonly used today for the production of prime label substrates as well as for the printing of decorative items, including the rendering of packaging. The technology employs a series of plates and one or more stations, containing inks (usually a different colored ink at each station) to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms, in cooperation with electronic scanners and image setters, to produce halftone images that are to be subsequently used to render an image. The pixels of digitized images are first assembled into dots that are then used to form shapes, sizes, rulings, etc. which create the ultimate image produced on the substrate.

Conventional pressure sensitive assemblies normally include a substrate having on one side a coating of adhesive, that is normally tacky to the touch, and a release liner disposed in a facial relationship with the adhesive to prevent the adhesive from coming into contact with the various processing surfaces of the apparatus that is handling the web of pressure sensitive material. The liner material will typically consist of a highly calendared stock to which a layer of silicone has been applied to one side of the stock. In use, the liner material is stripped away from the pressure sensitive adhesive assembly and is normally discarded. The adhesive will remain with the substrate to which it was originally applied as the adhesive has a greater affinity for the label substrate or sheets than for the carrier web or liner material as the label segments do not have a release coating applied to the surface in contact with the adhesive.

When utilizing conventional manufacturing and printing techniques to create prime labels, particularly glossy prime label products, an opaque liner material must be applied beneath the printing layer and then an adhesive layer and a covering release liner. Such a construction can delaminate over time, such as due to exposure to moisture, dramatic temperature changes and other environmental conditions. If any delamination occurs with such prime label products, the prime label product will normally be ruined.

Another problem that may be encountered with such conventional pressure sensitive label constructions is that some of the ink can be absorbed by the opaque or backer liner material thereby potentially diminishing the level of ink available for the image and possibly reducing, incrementally the resolution of the image. The application of such a backer liner may also serve to further flatten or spread out the ink dots generated from the printing device, which may potentially lead to bleeding or mixing of the ink colors and patterns that are intended to be generated by the printing device. Such bleeding or flattening of the image may reduce the clarity or sharpness of the image and detract from the appearance of the label product.

Another problem associated with such pressure sensitive prior art web assemblies is that the carrier web is normally fully coated with adhesive, that is the adhesive typically extends from edge to edge and side to side of the web, that portion of the label assembly. In such instances, when attempting to strip away the liner from the label assembly, the adhesive can strip off part of the backing from the printing and potentially damage the image.

What is needed therefore is a prime label construction that can be produced in a glossy configuration without suffering from the drawbacks associated with prior art constructions.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been found that by applying an over coating to an image that has been printed on a transparent or substantially transparent layer, with a pigmented material, such as a white opaque material, an image may be created that has a significantly improved level of resolution and the integrity of the prime label construction is enhanced by eliminating an interposed paper layer. By constructing the prime label product or intermediate label assembly in accordance with the present invention, the ink dot geometry is substantially preserved which is believed to improve the resolution of the image that is printed on the substrate. That is, the image may permit some level of dot growth on the surface of the substrate such that the image may stretch slightly upon application without suffering from microscopic cracking which may occur in conventional pressure sensitive label assemblies. In addition, it is believed, that by retaining a somewhat circular dot configuration, that is by not completely compressing the dot as may occur through the application of a solid ply backing layer, the image may be permitted to expand to some degree thereby allowing the prime label assembly to function in a number of different use applications.

In one exemplary embodiment provided in connection with the present invention, a prime label construction is described and includes a substantially transparent substrate that has first and second faces and first and second edges. An image applied to the second face of the substrate. The image is produced in a reverse format so as to be visible through the first face of the substrate.

A white pigmented layer is applied substantially entirely over the image and a layer of adhesive is applied substantially entirely over the white pigmented layer. A release liner is applied over the layer of adhesive.

In a further exemplary embodiment provided in connection with the present invention, a prime label intermediate construction is described and includes a substrate that has an image that is applied to one surface of the substrate in a reverse format.

An intermediate layer is applied over the image with the intermediate layer covering at least an area occupied by the image. The intermediate layer includes an adhesive component and a white pigmented component. A release liner is applied over the intermediate layer.

In a yet still further exemplary embodiment provided in connection with the present invention, a prime label construction is described and includes a substrate that has first and second faces, first and second transversely extending edges and first and second longitudinally extending sides. An image is printed in first and second areas of the substrate second face.

A white pigmented coating is applied over at least a portion of one of the first and second areas. An adhesive layer is applied substantially over the second face of the substrate and over the white pigmented layer and the image. A release liner is provided over the adhesive layer.

The pigmented component or layer can be provided so that it is substantially equally dispersed in the medium or alternatively, the pigmented layer can be provided such that certain portions of the layer are provided with higher levels of pigmentation and other portions of the layer are provided with lower levels of pigmentation, that is, the amount of pigmented material is dispersed in the second portion of the layer in an amount that is less than the dispersal rate in the first portion. In this manner, the image can appear to have a “fogged” or “fading” image in the second area whereas in the first area of the image, the image appears sharper than the second area. Heretofore, such arrangement of backing pigmentation was unavailable, as the backing layer was provided in a substantially continuous fashion. Through use of the present invention, the opaque material can create a gradient across the area of the image, such as moving from a high density of opaqueness to a lower density of opaqueness, or said another way the amount of pigmented or particulate material dispersed in the layer (be it the adhesive or separate layer) ranges from a more dense amount to a less dense amount.

The pigmentation layer may be provided substantially simultaneously with the adhesive layer. That is, the adhesive layer can be substantially clear such that the addition of particulate matter will add a layer of pigmentation to the adhesive as it is being applied to the substrate to create a substantially homogenous layer of material applied to the substrate. Alternatively, the adhesive layer may be applied separately from the layer of pigmentation.

The image may be printed in one or more different areas on the substrate and preferably at a resolution of greater than about 150 lines per inch and more preferably at greater than about 300 lines per inch.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross sectional view of the prime label intermediate produced in accordance with the present invention;

FIG. 2 shows a top view of the prime label product produced in accordance with the present invention;

FIG. 3 illustrates an alternative cross sectional view of the prime label intermediate produced in accordance with the present invention; and

FIG. 4 provides a schematic of a series of ink dots imaged in connection with the present invention and with a layer of pigmented material applied over the ink dots.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or for enhancing the image of the manufacturer or distributor or presenting the product as a high quality item. Prime labels are also used for business communications in that they can convey certain desirable criteria, image, brand recognition or information and can be used independently of a product, such as in connection with advertising a service opportunity or offering, or with other activities or undertakings, such as non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein, the term “business communication piece or document” refers to a substrate that, either alone or in combination with other documents, can convey a particular message or image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment, for example, could be subject to die cutting or additional printing, such as through ink jetting, over laminating, coating or embossment, and then applied to a container, carton, consumer package good or the like.

The glossy film stock that is used in accordance with the present invention is a clear polyethylene film that is laminated to the prime label segments either through the use of adhesive or alternatively by a heated roller that may shrink and seal the film directly over the surface of the prime label segments or activate the adhesive to adhere the adhesive to the segment. The film may also be pre-printed with indicia using the same high quality resolution imaging device as that used to print the sheets of material that will become the prime label segments. The printing may be complimentary to the printing on the sheets, for example a pictorial overlay that accentuates the textual image provided on the surface of the segments, so as to form a complete message.

In addition, the film stock can be partially transparent or clear and partially opaque or substantially translucent. The film may be applied in a continuous fashion over the surface of the web or alternatively, the film may be cut into individual pieces or segments with each segment being sized and configured to be about the size of the label segment.

An exemplary high resolution imaging device that is used in preparing the areas of the sheets that will become the prime label includes an Indigo®, available from Hewlett Packard of Palo Alto, Calif. or Karat available from KBA of Williston, Vt. The present invention seeks to provide a prime label or intermediate that has a quality of at least about 150 or more lines per inch and preferably more than 300 lines per inch, which is approximately equal to about 2500 to 3500 dots per inch (“DPI”) in order to create a high quality image that is intended to be aesthetically appealing to the consumer.

It has been discovered, that when the image is applied to the film, the ink dots that are generated by the printing device flatten partially on the surface of the film and that by then over coating the printing with an opaque, pigmented material, the integrity of the dots geometry is substantially retained. This surprisingly is different from prior art solutions, wherein a paper layer of material is applied over the dots, which further compresses the ink as well as causes some of the ink to be absorbed into the paper layer thus decreasing the level of ink dot integrity and resolution. Any absorption of the ink into the paper backing layer will likely diminish the image quality. In addition, as such images dry or cure, any bending of the label substrate may cause some level of microscopic cracking of the label image further contributing to the reduction in the quality of the label stock.

It is believed, that through the practice of the present invention, the amount of the external stresses on the ink dot configuration or the circular geometry of the ink pattern can be incrementally reduced thereby enabling the ink or particular ink dot pattern to coalesce better in order to retain the image design and quality of the printed image design and permit some level of image stretch due to potential dot growth.

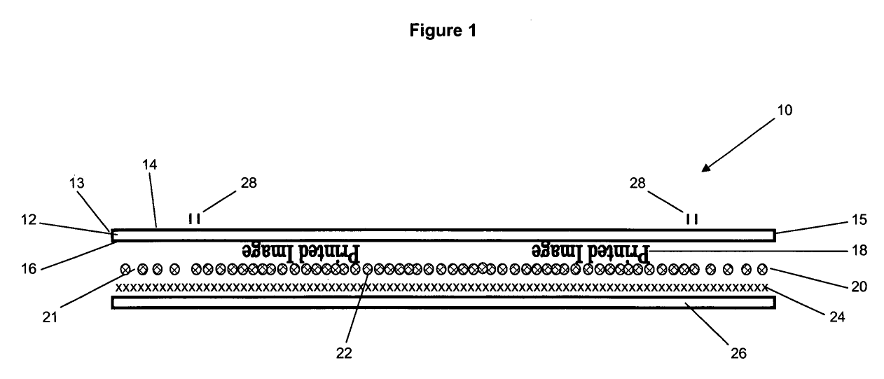

Reference is now directed to FIG. 1, which shows a cross sectional view of the prime label intermediate, generally designated by reference to numeral 10, produced in accordance with the present invention. The prime label intermediate 10 includes a top layer or substrate 12 which has first and second faces 14 and 16, respectively, and first and second ends 13 and 15, respectively.

The substrate 12 is preferably selected from a transparent or substantially transparent material, such as a polyethylene, polyvinyl or other polyester based material. The glossy film stock that is used in accordance with the present invention is a clear polyethylene film, such as PET, which has a thickness of less than 30 mils and preferably less than about 20 mils and still more preferably less than about 10 mils. The substrate 12 may be treated with a print receptive coating such as a polyvinyl alcohol (PVA) or other material that may be used to anchor toner or ink to the surface of the substrate 12. The substrate 12 may also include a translucent material or any combination of film based materials varying in opacity from one area to another of the substrate.

An image 18 is printed in a reverse format (upside down of “printed image” as shown in the FIGURE) on the second face 16 of the substrate 12. The image 18 may include graphics, text or a combination of each and preferably the image 18 is rendered using a non-impact printer which is capable of generating an image at a resolution of greater than about 150 or more lines per inch and preferably more than 300 lines per inch, which is approximately equal to about 2500 to 3500 dots per inch (“DPI”) in order to create a high quality image that is intended to be aesthetically appealing to the end user.

Disposed over the image 18 is a pigmented layer 20 which is illustrated by an “0” or rough diamond shape. The pigmented layer preferably consists of a white particulate material suspended in a curable medium. An exemplary material includes Phase 36 available from Arcar Graphics of West Chicago, Ill.. The pigmented layer 20 is shown ranging from a lower density area 21 to a higher density area 22 (where the amount of pigment or particulate matter occurs at a greater level than the lower density level). By providing the pigmented layer 20 in a gradient that can shift in density from one portion of the image to another (a first area to a second area), the image 18 can appear to be “shaded” or “fogged” such that a portion of the image 18 in which a higher density of pigmentation appears behind will have a sharper or more distinct appearance whereas an area where a lower density is disposed, the image will appear more washed out than the area backed by the higher density pigmented portion. That is, the opacity of the backing coating changes over the gradient such that more light will pass through areas in which a lesser amount of pigmentation is present such that the image will appear weaker in the areas backed by the lesser pigmentation areas.

A layer of adhesive 24 is applied over the pigmented backing layer 20. The layer of adhesive may be a permanent adhesive, removable adhesive or repositionable adhesive, or combination thereof, depending on the requirements of the end user. The adhesive is preferably applied so as to run the full width and length of the substrate 12, that is will cover the entire area of the substrate. Alternatively, the adhesive layer 24 may be applied in a pattern to accommodate a particular design or other configuration such as may be created in connection with a die cut construction to produce a design, shape or other arrangement.

Immediately adjacent to the adhesive layer 24 is a release liner 26. The release liner may be a highly calendared paper or other substrate, or may be a silicone or polyethylene coated stock material which will release from the adhesive coating upon applying a sufficient peeling pressure. That is, the adhesive will have a greater affinity to remain connected to the pigmented layer 24 as opposed to the liner layer 26, such that the prime label assembly 10 may be applied to a surface for use as a business or marketing communication piece.

Additional imaging 28 may be applied to the first face 14 of the substrate 12 such as bar coding, expiration date information, manufacturing source, product codes or any other information or data that may be beneficial in communicating to an end user or customer.

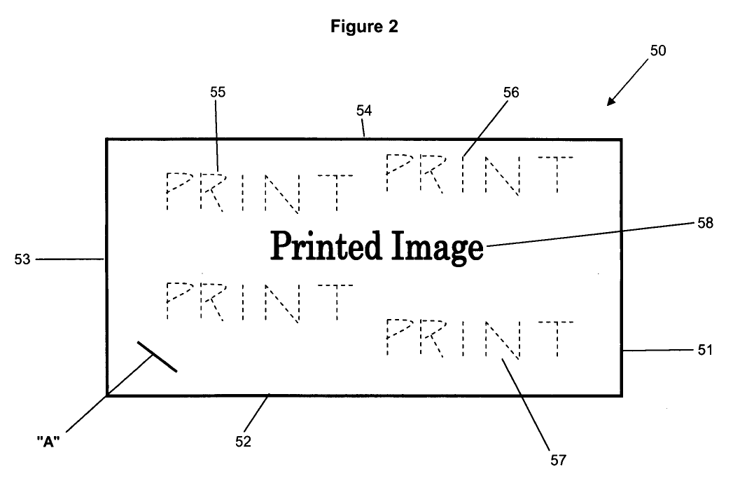

Reference is now directed to FIG. 2 of the presently described embodiments of the invention in which a prime label is represented generally by reference to numeral 50. The prime label 50 has first and second ends 51 and 53 respectively, and first and second sides 52 and 54, respectively. The image, which was printed in a reverse format as shown in FIG. 1, is visible through the first face designated as “A” in FIG. 2. The level of image resolution or sharpness is depicted by using several representations provided in FIG. 2. Image depiction provided by reference numeral 58 is intended to be sharper than the other image depictions. The sharper image depiction 58 will occur through the presence of a higher density of pigmentation in the underlying layer that is provided immediately adjacent the imaging, either in a separate layer or in a homogenous arrangement along with the adhesive layer or component. The lower or faded image depictions 55, 56 and 57 will occur due to lower pigmentation levels appearing behind the printed image. In this way, a faded or silhouette image can be created to the central image 58 thereby providing a unique arrangement to the printed image that has been provided. It should be understood that the image need not have these additional effects and that the underlying layer may be provided with a fully opaque coating so that the resolution or sharpness is consistent throughout the entire area of the printed portion of the prime label 50.

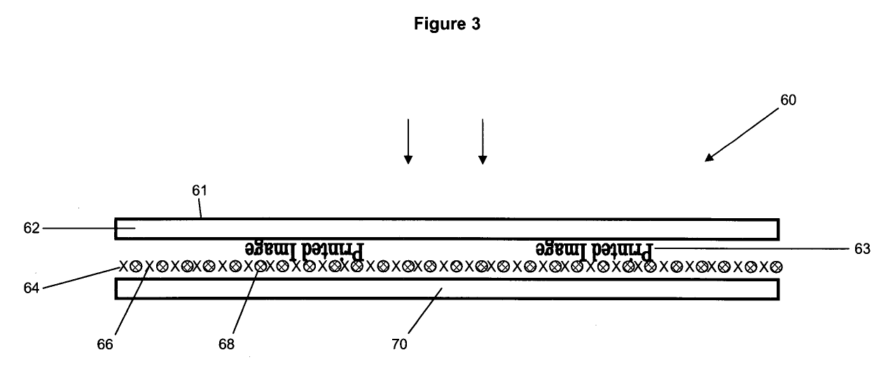

Reference is now directed to FIG. 3 of the presently described embodiments of the present invention in which an alternative cross section of a prime label intermediate is provided and generally referenced by numeral 60. The intermediate 60 includes a substrate 62 which is preferably a transparent or substantially transparent material such as a clear polyethylene film material. The substrate has first and second faces as previously described, and an image 63 is printed in a reverse format on the second face. With respect to reverse format, that means printing in a mirror image such that when viewing the image through the top or face side 61, also as shown by the directional arrows) of the transparent film, the image 63 will appear right side up or in a normal view, or be readable in the ordinary circumstance.

Immediately adjacent the image 63 is a relatively homogenous layer of pigmented adhesive or intermediate layer 64. That is, a clear adhesive (permanent, removable, repositionable) is provided and a particulate is added to the adhesive so that a dispersion of particulate, to create a level of opacity, is created in the adhesive. The dispersion of particulate may be varied throughout the adhesive to create a gradient of opacity for coating on the back of the image. That is, there may be higher or greater levels of densities of particulate than other areas to create a greater level of density and a lesser level of density than other areas. The intermediate layer 64 that is created by inclusion of adhesive and particulate includes adhesive, designated by reference numeral 66 and particulate designated by reference numeral 68. Immediately adjacent the intermediate level 64 is a release liner 70 that may be a calendar material or a polyethylene or silicone coated substrate.

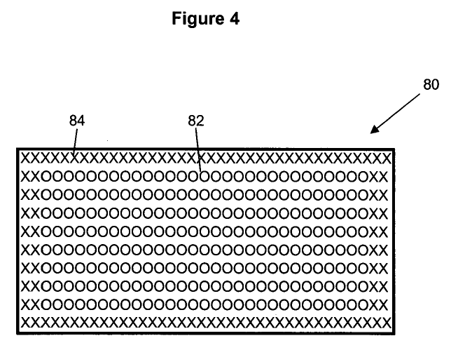

Turning now to FIG. 4, and without wanting to be bound to any particular theory or understanding, a schematic is presented representing a small section of an imaged area is designated by reference numeral 80. The sectional area includes a number of substantially, regularly occurring ink dots 82, represented by “o” which are interspersed with the pigmented coating 84 which is represented by a diamond shape.

It is believed that when printing the ink dots 82 on the substrate, the ink dots will flatten partially upon impact on the substrate (substantially transparent or transparent film), that is the dots will not be absorbed by the material onto which the ink is printed. The ink will remain on the surface of the substrate until cured, or until pressure is applied and the ink is otherwise absorbed. However, it is suspected that by providing an opaque coating that will surround the ink dots as opposed to a backing material that will create incremental pressure over the surface of the dots such as may occur with a sheet as is commonly accomplished in the prior art, the ink dots will remain in a partially flattened condition and be partially suspended within the opaque coating so that the surface geometry does not change and the individual ink dots are protected from further flattening.

It will thus be seen according to the present invention a highly advantageous prime label construction and intermediate has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A prime label construction, comprising;
a substantially transparent substrate having first and second faces and first and second edges and first and second sides;
an image applied to said second face of said substrate, said image is produced in a reverse format so as to be visible through the first face of the substrate;
a white pigmented layer applied substantially entirely over said image, said pigmented layer creating an opaque backing for said image;
a layer of adhesive applied substantially entirely over said white pigmented layer; and
a release liner applied over said layer of adhesive.

2. A prime label construction as recited in claim 1, wherein said release liner extends substantially between said first and second edges of said substrate.

3. A prime label construction as recited in claim 1, wherein said adhesive layer is substantially clear.

4. A prime label construction as recited in claim 1, wherein said white pigmented layer and said adhesive layer are applied substantially simultaneously.

5. A prime label construction as recited in claim 1, wherein said white pigmented layer is provided over said image ranging from a high density of particulate material to a low density of particulate material.

6. A prime label construction as recited in claim 1, wherein said adhesive layer is provided in a pattern substantially equivalent to said image.

7. A prime label construction as recited in claim 1, wherein said image is produced at a resolution of greater than about 150 lines per inch.

8. A prime label intermediate construction, comprising;
a substrate having first and second faces, first and second end edges and first and second end sides;
an image is applied to one of said first and second faces of said substrate in a reverse format;
an intermediate layer is applied over said image, said intermediate layer covering at least an area occupied by said image and said intermediate layer including an adhesive component and a white pigmented component to provide at least an opaque coating for said image; and
a release liner applied over said intermediate layer.

9. A prime label intermediate construction as recited in claim 8, wherein said substrate is substantially transparent.

10. A prime label intermediate construction as recited in claim 8, wherein said adhesive component and said pigmented component are provided in a substantially homogenous arrangement.

11. A prime label intermediate construction as recited in claim 10, wherein said pigmented component is dispersed substantially equally throughout said adhesive component.

12. A prime label intermediate construction as recited in claim 8, wherein said pigmented component is applied over said image ranging from a high density of particulate material to a low density of particulate material.

13. A prime label intermediate construction as recited in claim 8, wherein said adhesive component is substantially adjacent said release liner.

14. A prime label intermediate construction as recited in claim 8, wherein said pigmented component is substantially opaque.

15. A prime label construction, comprising;
a substrate having first and second faces, first and second transversely extending edges and first and second longitudinally extending sides;
an image printed in first and second areas of said substrate second face;
an white pigmented coating applied said first and second areas, said white pigment coating is applied in a density gradient between said first area and said second area, such that said density gradient applied over said first area is greater than said density gradient applied over said second area;
an adhesive layer applied substantially over said second face of said substrate and over said white pigmented layer and said image; and
a release liner provided over said adhesive layer.

16. A prime label construction as recited in claim 15, wherein said white pigmented layer creates a substantially opaque layer behind said image in one of said first and second areas.

17. A prime label construction as recited in claim 15, wherein said adhesive layer is selected from a group including permanent, removable and repositionable adhesives.

18. A prime label construction as recited in claim 15, wherein said pigmented coating is applied substantially over each of said first and second areas of said image in a distinct density gradient.

19. A prime label construction as recited in claim 15, wherein said pigmented coating substantially covers said first area and partially covers said second area of said image.

20. A prime label construction as recited in claim 15, wherein said image is printed in a reverse format so as to be visible through said substrate when viewed through said first face.
